(19) United States
(12) Patent Application Publication
(10) Pub. No.: US 2020/0251763 A1
(43) Pub. Date: Aug. 6, 2020

(54) POWER TRANSMISSION SYSTEM

(71) Applicant: PLANSEE SE, REUTTE (AT)

(72) Inventors: THOMAS FRIEDRICH, REUTTE (AT); MARKUS HAYDN, GUNTRAMSDORF (AT)

(21) Appl. No.: 16/652,138

(22) PCT Filed: Sep. 19, 2018
(86) PCT No.: PCT/AT2018/000075

§ 371 Date: Mar. 30, 2020

(30) Foreign Application Priority Data
Oct. 2, 2017 (AT) GM 220/2017

(51) Int. Cl. H01M 8/2465

(52) U.S. Cl. CPC H01M 8/2465

(57) ABSTRACT

A power transmission system enables the electrical contacting of a stack with a power line or with an adjacent stack. The stack is made up of a plurality of planar electrochemical modules and is closed off at each of the end faces by a stack-side power transmission plate. The power line to be contacted ends with a line-side power transmission plate. The power transmission system comprises at least one porous, metallic body which is arranged between the stack-side power transmission plate of the stack to be contacted and the line-side power transmission plate of the power line or the stack-side power transmission plate of the adjacent stack and is electrically connected to these power transmission plates. In addition, the porous, metallic body is sealed in a gastight manner by a closed circumferential seal.

The present invention relates to a power transmission system as claimed in claim 1.

The power transmission system is employed in the electrical contacting of a stack made up of electrochemical modules, for example a high-temperature fuel cell or solid oxide fuel cell (SOFC), a solid oxide electrolyzer cell (SOEC) or a reversible solid oxide fuel cell (R-SOFC). The electrochemical modules are arranged on top of one another in conjunction with appropriate components (interconnect, housing parts, gas conduits, etc.) to form a stack and electrically contacted in series. The electrochemical modules are usually configured as flat individual elements and comprise a gastight solid electrolyte which is arranged between a gas-permeable anode and a gas-permeable cathode.

In operation of the electrochemical module as SOFC, fuel (for example hydrogen or customary hydrocarbons such as methane, natural gas, biogas, etc., optionally completely or partially prereformed) is supplied to the anode and catalytically oxidized there with release of electrons. The electrons are conducted out of the fuel cell and flow via an electric load to the cathode. At the cathode, an oxidant (for example pure oxygen, but usually air) which has been introduced is reduced by uptake of the electrons. The electric circuit is closed by the oxygen ions (protons) formed at the cathode flowing through an electrolyte which is conductive for oxygen ions (or in the case of a more recent generation of SOFC, for protons) to the anode and reacting with the fuel at the corresponding interfaces.

In operation of the electrochemical module as solid oxide electrolysis cell (SOEC), a redox reaction is induced using electric power, for example a conversion of water into hydrogen and oxygen. The structure of the SOEC corresponds essentially to the structure of an SOFC outlined above, with the roles of cathode and anode being exchanged. A reversible solid oxide fuel cell (R-SOFC) can be operated both as SOEC and as SOFC.

The present invention is concerned with the electrical contacting of such a stack arrangement. Whereas the electrical connection between the electrochemical modules within a stack is effected via so-called interconnects, electrically conductive power transmission plates (base and covering plates) are provided at the end faces of the stack in a plant for further transmission of power from one stack to an adjacent stack or on an external power line. These enable power to be tapped from or supplied to the stack and additionally mechanically reinforce the stack. These stack-side power transmission plates have frequently been produced powder-metallurgically and are therefore difficult to subject to mechanical post-processing and challenging to contact electrically. It is known that, to achieve this electrical contacting, power outlet tabs or plates can be welded or soldered onto the base or covering plates, for example by means of an electrically conductive glass (DE 43 07 666 C1), or electrical connection can be established by application of an electrically conductive ceramic coating. In DE 10 2004 008 060 A1, power connection is effected via a stranded cable whose strands are stamped into holes on the base or covering plates of the stack. The electrical contact of the stack is challenging since the electrochemical modules are operated at an operating temperature of up to 1000° C. and the electrical contacting means are therefore subjected to correspondingly high temperatures in an oxidizing atmosphere (generally ambient air). In addition, relatively high currents flow at comparatively low voltages (a single SOFC provides voltages in the order of 1 V, and current densities of up to 500 mA/cm² occur, with SOFCs having electrochemically active layers having an area in the order of 100 cm² or more typically being used). The problems of electrical contacting will become of greater importance in the future since significantly higher current densities than those just described are expected because of further developments in the field of the electrochemical modules.

It is an object of the present invention to develop an electric power transmission system for a stack made up of electrochemical modules further, which can be implemented inexpensively and reliably allows virtually loss-free electrical contacting of the stack at high operating temperatures of the stack of up to 1000° C. The electric power transmission system should allow both direct electrical contacting of a stack with an adjacent stack and electrical contacting of a stack with an external power line in a plant.

This object is solved by a power transmission system having the features of claim 1. Advantageous embodiments of the invention are indicated in the dependent claims.

The power transmission system of the invention serves to electrically contact a stack with a power line, in particular a cable-like power line, for example an external power cable, or to directly electrically contact a stack with an adjacent stack. Here, the stack to be contacted is in each case in the form of a stack made up of at least one planar electrochemical module, in particular a solid oxide fuel cell (SOFC), a solid oxide electrolysis cell (SOEC) or a reversible solid oxide fuel cell (R-SOFC). Such a stack usually consists of a plurality of electrochemical modules. The stack is closed off at its end faces by, in each case, a stack-side power transmission plate, which is also described or referred to as base or covering plate, and apart from its electrical function usually also brings about mechanical cohesion of the, generally many, individual electrochemical modules of the stack. If the stack is to be contacted with a power line, an end of the power line is electrically connected to a line-side power transmission plate. The power transmission plates are electrically conductive and in particular metallic. While the stack-side power transmission plates have generally been produced powder-metallurgically, the line-side power transmission plate can be produced melt-metallurgically, for example be made of high-temperature-resistant steel. The cable-like power line can be connected significantly more easily and more reliably with a melt-metallurgically produced power transmission plate, for example by means of a welded connection, than when the powder-metallurgically produced, stack-side power transmission plate is contacted directly.

The power transmission system comprises at least one porous, metallic body which, if two stacks are to be contacted directly with one another, is arranged between the stack-side power transmission plate of the first stack to be contacted and the stack-side power transmission plate of the adjacent second stack to be contacted or, if a power line is contacted, is arranged between the stack-side power transmission plate of the stack to be contacted and the line-side power transmission plate of the power line to be contacted. The porous, metallic body is electrically connected to the respective power transmission plates and sealed in a gastight manner by a closed circumferential seal, in particular against an oxidizing environment such as ambient air. The porous metallic body thus serves to transmit power between the power transmission plates to be contacted. The porous metallic body is preferably configured as a component separate from the power transmission plates to be contacted. It is, in particular, sheet-like with a surface matched to the power transmission plates. Sheet-like contacting is advantageous since the current densities occurring at a given current flow from stack to stack or from stack to power line are then smaller. For the purposes of the present disclosure, the porous metallic body is not necessarily a porous, powder-metallurgically produced metallic body. The term porosity should be interpreted in general terms here and encompasses any body which is not made up of a solid material and whose structure thus has some voids or hollow spaces. The porous metallic body can, for example, have a mesh-, nonwoven- or sponge-like structure. In particular, the porous body can be an insert made of a metallic mesh, gauze, woven fabric, formed-loop knit, drawn-loop knit, nonwoven, sponge or the like.

As an alternative, the porous metallic body can be a powder-metallurgically produced component. Despite the voids such as the pores in a powder-metallurgically produced body, the structure of the porous body has at least one electrically conductive path between the power transmission plates to be contacted; a very large number of electrically conductive paths is clearly advantageous. Accordingly, the structure of the body is percolating in respect of its electrical conductivity in the case of a powder-metallurgically produced body.

In comparison with a body made of a solid material, the porosity provides additional space in which the material can expand when the temperature increases, so that thermal stresses due to different coefficients of thermal expansion can be dissipated in the power transmission system and the gastightness, by means of which the porous body is protected against its oxidizing environment, is not endangered by thermally induced stresses.

The gastight sealing of the porous body against an oxidizing environment such as ambient air is produced by a seal which runs around and encloses the porous, metallic body. The seal preferably extends between the power transmission plates to be contacted and in each case forms a material-to-material bond to the power transmission plates to be contacted, as a result of which a mechanical connection between the power transmission plates to be contacted is at the same time established. Suitable materials for the seal are, in particular glass solder, mica or a high-temperature adhesive which is sufficiently heat-resistant and retains its adhesive properties up to the planned operation temperatures. The seal material, for example the glass solder, can be applied in viscous form by means of a dispenser to the surface of one of the power transmission plates to be contacted or to both surfaces of the power transmission plates to be contacted. The seal material hardens after the joining process between the two surfaces of the power transmission plates to be contacted, in the case of the glass solder partially or fully crystalline. A mechanical connection of the two power transmission plates is thus achieved in addition to the gastight separation from the environment. The seal can also be placed in solid form, for example as stamped circumferential frame composed of glass solder sheet, on a surface of a power transmission plate to be contacted and subsequently joined to the surface of the second power transmission plate to be contacted. Depending on the seal material used, the application of a mechanical load, with the mechanical loading being exerted by the power transmission plates onto the seal, during and/or after the joining process can be advantageous. Such mechanical loading can occur or be applied by means of, for example, pneumatic pistons, weights or the intrinsic weight of a stack. As a result of the seal, the selection of the material for the power-conducting element, namely the porous, metallic body, does not remain restricted to expensive noble metals or other particularly corrosion-resistant or oxidizing-resistant materials, but instead it is also possible to use less expensive materials which were without protection oxidized on its surface in an oxidizing atmosphere such as ambient air at operating temperatures of up to 1000° C. to form electrically insulating layers. As suitable metals for the porous body, mention may be made of: nickel, copper, chromium, iron, molybdenum and tungsten. The use of nickel is particularly preferred because nickel is used in any case in other components of the stack and also oxidizes only at relatively high partial pressures and nickel oxide layers are not completely electrically insulating. It is naturally also possible to use alloys based on one of the abovementioned metals, high-temperature-resistant alloys based on zinc, tin or lead or else high-temperature-resistant steels such as steels having a high alloying content of chromium 20% by weight of chromium) or steels having a high alloying content of nickel 20% by weight of nickel).

A great advantage of the power transmission system presented is that inevitable differences in the thermal expansion behavior between the material of the power cable or the material of the line-side power transmission plate and the stack-side power transmission plate can be more easily compensated for by the components located inbetween as buffers. The risk of crack formation, etc., as can occur in the prior art in the case of soldered-on or welded-on power outlet tabs or plates, is significantly reduced by means of the present invention.

It has been found to be advantageous during and after joining of the two power transmission plates to be contacted for the power transmission plates to be contacted to be separated from one another by at least one spacer which is preferably arranged between the power transmission plates to be contacted. The at least one spacer should, even at relatively high temperatures, ensure a defined spacing and, in particular, parallel orientation of the joined power transmission plates. In addition, it has been found to be advantageous for the spacer not to have completely rigid behavior but to exhibit a certain elasticity in a direction normal to the plane of the two power transmission plates. As spacers, it is possible to use ceramic or metallic plates, pins, felts, nonwovens or the like. The spacer or spacers does/do not have to be configured as separate component but can also be configured as integral part of one of the two power transmission plates. The dimensions of the porous metallic body, the spacer or spacers and the seal clearly have to be matched to one another. The height of the spacer (in the direction of the electric connection) is typically in the order of mm.

In an advantageous embodiment, the porous metallic body is, especially when configured as mesh-, nonwoven- or sponge-like structure, compressible and is laid or clamped under pressure between the two power transmission plates to be contacted. The compression of the porous body and the corresponding force exerted between porous metallic body and power transmission plate can establish a low-ohm electrical contact with the power transmission plates over the entire contact area of the porous body.

The coefficient of thermal expansion of the seal material should be matched to the coefficient of thermal expansion of the material of the porous metallic body, with the two coefficients of thermal expansion preferably differing by not more than 10*10⁻⁶ K⁻¹, particularly preferably by not more than 6*10⁻⁶ K⁻¹. If it is not possible to avoid a difference between the coefficients of thermal expansion, it is advantageous for the material of the porous, metallic body to expand somewhat more than the seal material when the temperature is increased rather than the converse, so that the electrical contacting is not interrupted by a comparatively small expansion of the porous body even at relatively high temperatures. Any somewhat greater thermal expansion of the seal material can be compensated for over a certain temperature range by the abovementioned mechanical pressure on the porous body.

In order to achieve a required height in the electrical connection direction, a plurality of porous, metallic bodies can be stacked on top of one another in the electrical connection direction. Stacking can be effected loosely or can be assisted by a material-to-material bond, for example by means of point welding. As an example, mention may be made of inserts composed of a metallic mesh, gauze, nonwoven, sponge or the like which are stacked on top of one another and gently compressed between the power transmission plates to be contacted and are optionally joined to one another by means of point welding.

In order to distribute the current over a larger cross-sectional area, it is possible, in an advantageous embodiment, for a plurality of porous, metallic bodies to be arranged spatially separately from one another along the main plane of extension of the power transmission plates between the two power transmission plates to be electrically contacted. The individual porous, metallic bodies are in each case sealed in a gastight-manner by means of a closed circumferential seal and thus form independent power transmission units which are electrically connected in parallel. In this way, the current density is reduced and at the same time redundancy is achieved for the event of individual power transmission units acquiring a higher ohmic resistance or failing.

In an advantageous embodiment, the sealed interior space with the porous metallic body is opened through the stack-side power transmission plate to be contacted to the fuel gas space of the neighboring electrochemical module, so that gas exchange with the reducing atmosphere of the fuel gas space is made possible. This prevents residual oxygen which has, for example, remained in the sealed interior space from the manufacture of the power transmission system from oxidizing the porous metallic body over the course of time.

To supply the electrochemical modules with process gases, for example to feed in fuel gas or discharge offgas, pipes are provided within the stack. In an advantageous embodiment, these are passed through the stack-side or line-side power transmission plates. For this purpose, through-openings are integrated into the stack-side power transmission plates and/or line-side power transmission plates.

In summary, the power transmission system of the invention offers an inexpensive and reliable solution to connecting a stack in a plant to an external power cable. Furthermore, the power transmission system makes it possible to connect two adjacent stacks directly to the stack-side power transmission plates. Adjacent stacks can naturally also be contacted indirectly via a power cable connected inbetween, with the power cable being connected at each end to a line-side power transmission plate which is then contacted with the corresponding stack-side power transmission plate.

Further advantages of the invention may be derived from the following description of working examples with reference to the accompanying figures, in which the size ratios are not always shown true to scale for purposes of illustrating the present invention. In the various figures, the same reference numerals are used for corresponding components.

The figures show:

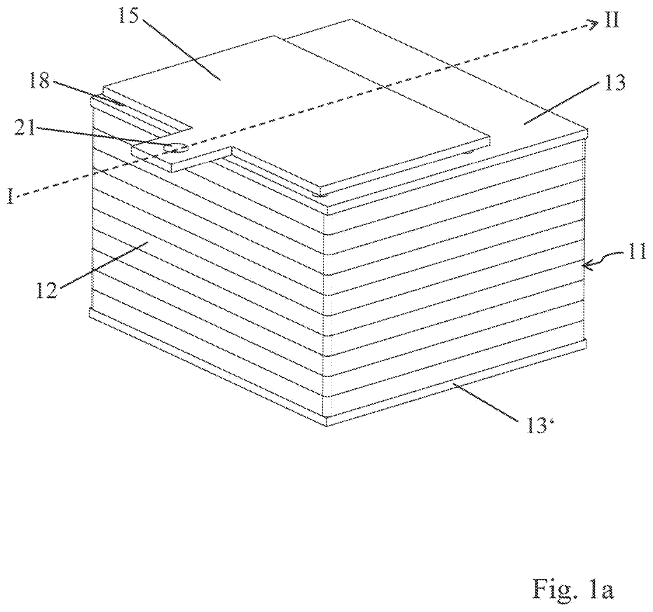

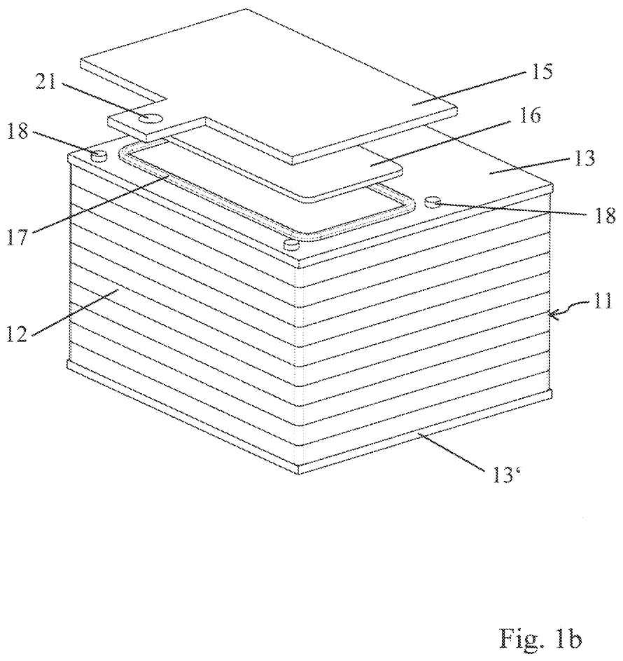

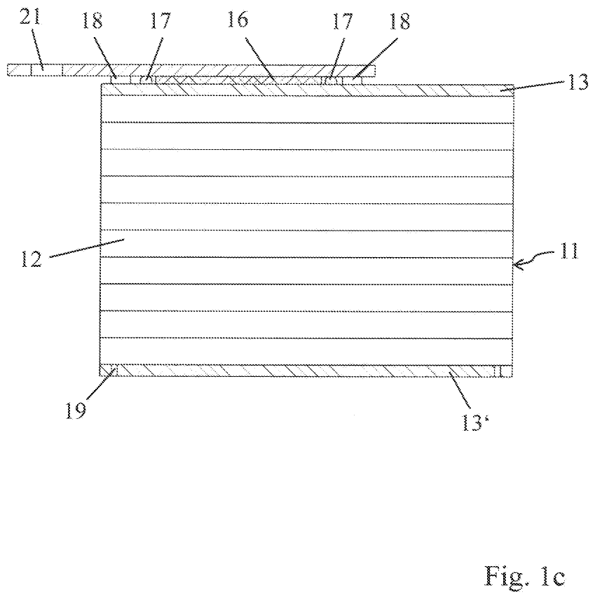

FIG. 1a: a schematic perspective view of a power transmission system as per a first embodiment of the invention;

FIG. 1b: an exploded view of the power transmission system of FIG. 1a;

FIG. 1c: a schematic cross-sectional view of the power transmission system of FIG. 1a along the line I-II;

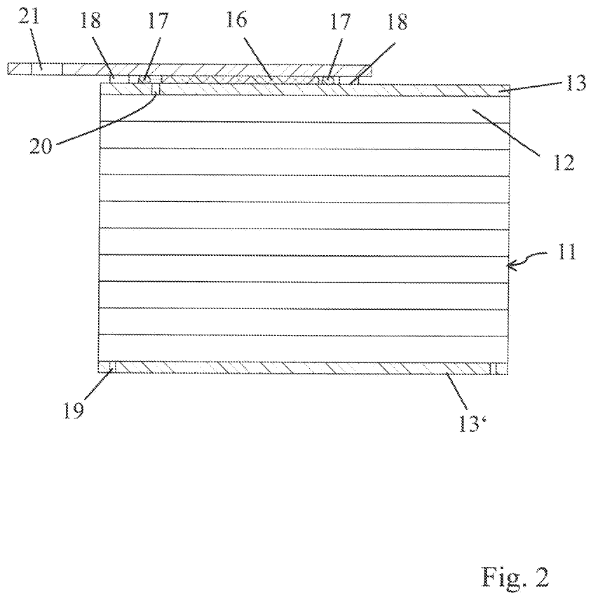

FIG. 2: a schematic cross-sectional view of a power transmission system as per a second embodiment of the invention;

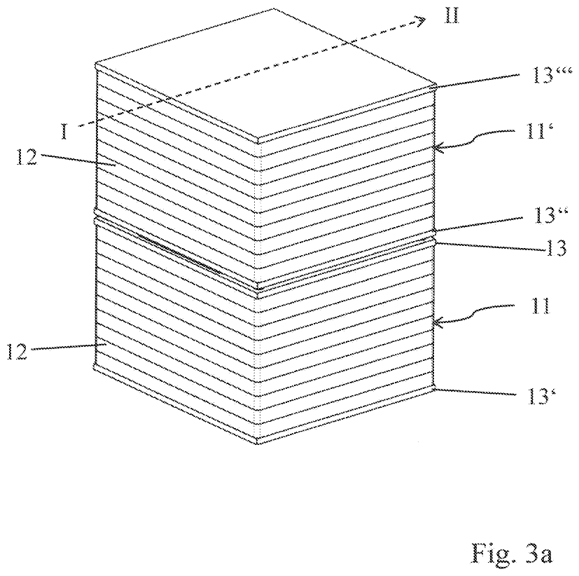

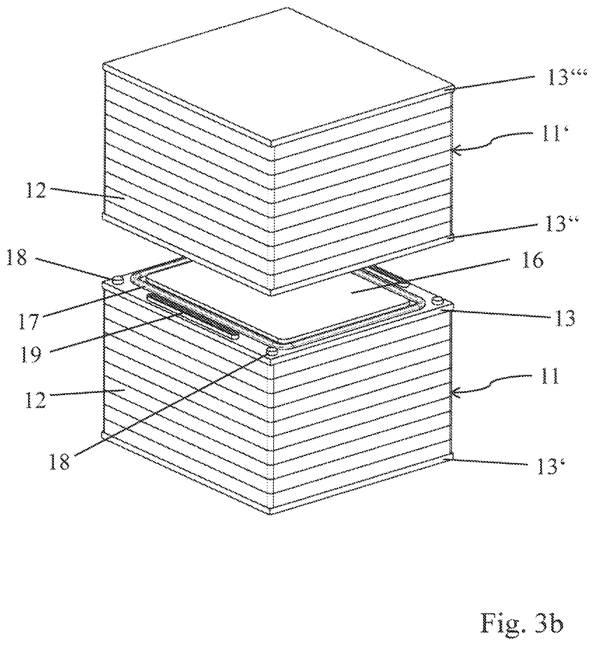

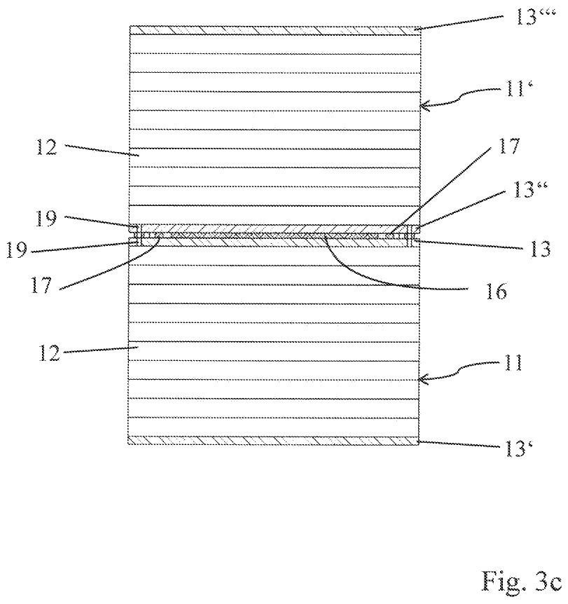

FIG. 3a: a schematic perspective view of a power transmission system as per a third embodiment of the invention;

FIG. 3b: an exploded view of the power transmission system of FIG. 3a;

FIG. 3c: a schematic cross-sectional view of the power transmission system of FIG. 3a along the line I-II.

FIG. 1a to FIG. 3c each show a perspective view or a corresponding cross-sectional view of a first, second and third embodiment of the power transmission system of the invention. FIG. 1a, FIG. 1b, FIG. 1c and FIG. 2 schematically show a stack comprising a power transmission system by means of which a power cable is contacted (the power cable is not shown and can be electrically contacted via the hole 21 with the line-side power transmission plate 15), while FIGS. 3a, 3b and 3c show a power transmission system in which directly adjacent stacks are electrically connected directly to one another. The stacks 11, 11′ shown each consist of electrochemical modules 12, for example SOFCs, which are stacked on top of one another and electrically connected in series and the stacks are closed off at each of the two end faces by a stack-side power transmission plate (base or covering plate) 13,13′,13″,13′″. The stack-side power transmission plates have been powder-metallurgically produced from a powder batch composed of 95% by weight of elemental chromium powder and 5% by weight of a prealloy powder composed of iron with 0.8% by weight of yttrium.

To establish contact with the cable-like power line, the end of the power line (not shown) is pushed into the hole 21 of the line-side power transmission plate 15 and electrically connected thereto. The line-side power transmission plate 15 consists of a high-temperature-resistant, melt-metallurgically produced steel such as X1CrWNbTiLa22-2 (obtainable under the tradename Crofer® 22 H) or X1 CrTiLa22 (obtainable as Crofer® 22 APU) and is therefore likewise electrically conductive. The line-side power transmission plate 15 is electrically connected to the stack-side power transmission plate 13 via a nickel gauze, the porous metallic body 16, located inbetween. To produce reliable and low-ohm contacting over the entire contact area of the metallic gauze 16 with the power transmission plates 13; 15, the metallic gauze 16 is laid between the two power transmission plates 13, 15 to be contacted, gently pressed together and the line-side power transmission plate 15 which has been placed on top is loaded with a weight during the joining process. Instead of a single gauze, it is also possible to stack a plurality of gauzes on top of one another. The power-conducting element 16 does not necessarily have to be configured as gauze, but instead it is also possible to use inserts composed of a metallic mesh, woven fabric, formed-loop knit, drawn-loop knit, nonwoven, sponge or the like or a powder-metallurgically produced porous component. The metallic gauze 16 or a stack of a plurality of gauzes placed on top of one another is sealed in a gastight manner from the surroundings by a closed circumferential seal 17. As material for the seal 17, use was made of glass solder which is applied in viscous form by means of a dispenser to the surface of one of the two power transmission plates or to the surface of both power transmission plates. The glass solder hardens after joining of the two power transmission plates 13, 15 to be contacted and by material-to-material bonding also establishes a mechanical connection between the two power transmission plates 13, 15 to be contacted. The coefficient of thermal expansion α₍₂₀₋₉₅₀₎ of the glass solder used is about 8·10⁻⁶ K⁻¹ and is thus slightly lower than the coefficient of thermal expansion of nickel (at 20° C.: 13.4·10⁻⁶ K⁻¹). Owing to the seal 17, the power-conducting element 16 does not have to be made of expensive noble metals or otherwise particularly corrosion-resistant or oxidation-resistant materials and recourse can be made to inexpensive materials such as nickel. Optional spacers 18 ensure parallel orientation of the joined power transmission plates 13, 15. Ceramic or metallic plates, pins, felts or the like have been found to be useful as spacers 18. The power transmission system realized in this way saves space and can also be realized very inexpensively since, firstly, inexpensive materials can be used and, in addition, manufacture makes do with only a few working steps. It is naturally also conceivable to use a plurality of power transmission units which are electrically connected in parallel instead of one power transmission unit for further conduction of the power from or to the power transmission plate. This creates redundancy for the event of individual power transmission units acquiring a higher ohmic resistance or failing.

The embodiment shown in FIG. 2 is slightly modified compared to the first embodiment: the sealed interior space with the gauze 16 is opened by means of the hole 20 through the stack-side power transmission plate 13 to the fuel gas space of the neighboring electrochemical module, so that gas exchange with the reducing atmosphere of the fuel gas space is made possible. This has the advantage that residual oxygen which has remained in the sealed interior space on joining of the two power transmission plates 13, 15 is displaced during the course of first operation.

FIG. 3a, FIG. 3b and FIG. 3c show a power transmission system in which a stack 11 is contacted not with a power cable but directly with a directly adjacent stack 11′. The sheet-like porous metallic body 16 is clamped between the two stack-side power transmission plates 13, 13″ of the adjacent stack. In FIG. 3a, it is also possible to see gas passage openings 19 in the stack-side power transmission plate 13, through which openings process gases (fuel gas or offgas) are conveyed from one stack 11 into the adjacent stack 11′. These gas passage openings 19 are likewise sealed from the environment by means of glass solder. Adjacent stacks 11, 11′ can naturally also be contacted indirectly by means of a power cable located inbetween in a manner analogous to working example 1.

1-15. (canceled)

16. A power transmission system for electrically contacting a stack with a power line or with an adjacent stack,
wherein the power line to be contacted ends with a line-side power transmission plate and a stack to be contacted is in each case made up of a stack of at least one planar electrochemical module that is closed at each end face thereof by a stack-side power transmission plate;
the power transmission system comprising:
at least one porous, metallic body arranged between the stack-side power transmission plate of the stack to be contacted and the line-side power transmission plate of the power line or the stack-side power transmission plate of the adjacent stack and said porous, metallic body being electrically connected to the power transmission plates; and
a closed circumferential seal disposed to form a gastight seal around said porous, metallic body.

17. The power transmission system according to claim 16, further comprising at least one spacer disposed to keep the power transmission plates to be contacted at a distance from one another.

18. The power transmission system according to claim 16, wherein said porous, metallic body is configured as a separate component.

19. The power transmission system according to claim 16, wherein said at least one porous, metallic body is clamped between the power transmission plates to be contacted.

20. The power transmission system according to claim 16, wherein said circumferential seal extends circumferentially around said porous, metallic body between the power transmission plates to be contacted.

21. The power transmission system according to claim 16, wherein said porous metallic body is powder-metallurgically produced component having a percolating structure in respect of an electrical conductivity thereof.

22. The power transmission system according to claim 16, wherein the porous metallic body has a mesh structure, a nonwoven structure, or a sponge structure.

23. The power transmission system according to claim 16, wherein a plurality of porous, metallic bodies are stacked on top of one another in an electrical connection direction between the power transmission plates to be electrically contacted.

24. The power transmission system according to claim 16, wherein a plurality of porous, metallic bodies are arranged between the two power transmission plates to be electrically contacted and are spatially separated from one another and in each case sealed in a gastight manner by a closed circumferential seal.

25. The power transmission system according to claim 16, wherein the porous, metallic body is formed from a metal selected from the group consisting of nickel, copper, chromium, iron, molybdenum, tungsten, vanadium, manganese, niobium, tantalum, titanium, cobalt, and an alloy containing at least one of these metals.

26. The power transmission system according to claim 16, wherein the closed circumferential seal is made of glass solder, mica, or a high-temperature adhesive.

27. The power transmission system according to claim 16, wherein material of said porous, metallic body has a coefficient of thermal expansion that is higher than a coefficient of thermal expansion of a material of said seal.

28. The power transmission system according to claim 27, wherein the coefficient of thermal expansion of the material of said seal and the coefficient of thermal expansion of the material of said porous, metallic body differ from each other by not more than 10*10⁻⁶ K⁻¹.

29. The power transmission system according to claim 16, wherein the stack-side power transmission plates of the stack and/or the line-side power transmission plate of the power line is formed with through-openings for an introduction or discharge of process gases.

30. The power transmission system according to claim 16, wherein a through-opening is formed in the stack-side power transmission plate to be contacted of the stack within a region enclosed by said seal so as to allow gas exchange with a sealed process gas space operated in a reducing atmosphere in the electrochemical module.
